(19) United States
(12) Patent Application Publication
(10) Pub. No.: US 2004/0003301 A1
(43) Pub. Date: Jan. 1, 2004

(54) Methods and apparatus to control processor performance to regulate heat generation

(76) Inventor: Don J. Nguyen, Portland, OR (US)

Correspondence Address: GROSSMAN & FLIGHT, LLC, 20 NORTH WACKER DRIVE, SUITE 4220, CHICAGO, IL, 60606, US

(21) Appl. No.: 10/185,345

(22) Filed: Jun. 28, 2002

(51) Int. Cl. G06F 1/26

(52) U.S. Cl. 713/300

(57) ABSTRACT

Methods and apparatus for controlling processor performance to regulate heat generation are disclosed. For example, a power monitor is provided for use in a computer having a processor. The example power monitor includes a current sense resistor associated with a power input of the processor and an amplifier in communication with the current sense resistor to develop a signal representative of power dissipated by the processor. The power monitor also includes a comparison circuit to compare the signal output by the amplifier with a predetermined threshold.

### FIELD OF THE DISCLOSURE

This document relates generally to personal computers and, more particularly, to methods and apparatus for controlling processor performance to regulate heat generation in a personal computer.

### BACKGROUND

Portable computers such as notebook and laptop computers have become increasingly popular. This increased popularity has been driven in part by decreases in the size and weight of these devices. However, while users of such portable computers avidly desire smaller and lighter computers, they typically are not willing to sacrifice computing performance to obtain these reductions. Instead, the portable computer is expected to achieve the same, or nearly the same, level of computing performance as a desktop computer.

These expectations necessarily require utilization of a high performance processor in a much smaller enclosure or housing in the portable computer context than is available in the desktop context. This combination of a high performance processor and a small housing translates into a significant thermal design challenge. In particular, it is significantly more difficult to cool a processor in the confines of a portable computer housing than to cool a processor in the relatively spacious housing of a desktop computer.

A typical thermal solution (e.g., heat dissipation elements such as a fan, heat sinks, etc.) is designed to address the normal power usage case. To this end, the thermal design power (PTDP) of a processor is typically specified at 60-70% of the maximum theoretical power demand (i.e., the power demanded by the processor when almost all of its transistors are toggling as might occur, for example, in response to a power virus application). More specifically, PTDP is sometimes defined as the sum of 70% of the processor's dynamic power (PDYN) and 100% of the processor's leakage power (PLEAK) (i.e., PTDP=70% PDYN+PLEAK).

Leakage power (PLEAK) is the power dissipation of the processor when the processor is in an idle or sleep state. To minimize leakage power, the operating voltage is dropped as low as possible when a processor enters a sleep state. However, the need to retain logic limits the level to which this voltage can be reduced. Thus, there is power dissipation through leakage power even when the processor is in a sleep or idle state. Moreover, the leakage power (PLEAK) of a processor is temperature dependent. As temperature increases, leakage power also increases.

The dynamic power (PDYN) is directly proportional to the square of the operating voltage (V) and operating frequency (F) of the processor in accordance with the following equation: PDYN∝V²F. Thus, as the processor frequency (F) increases, the dynamic power increases. Further, as frequency (F) increases, the operating voltage (V) to support the increased frequency must also increase. Therefore, increasing the operating frequency dramatically increases the dynamic power drawn by the processor.

Complicating matters further, due to variations in the fabrication process and other factors, thermal design power (PTDP) varies significantly from one processor to another. To address such variations, manufacturers such as Intel specify the thermal design power (PTDP) to include tolerances or guard bands. Moreover, the frequency of the processor is often increased in the field over its useful life through technological advances of various types. To address these increases, the guard bands are specified to enable the processor to function without emergency shutdowns due to excessive heat over its entire expected life. In short, the thermal solution is typically over designed to address these possible variations.

However, due to the practical space constraints in a portable computer, the thermal solution can only be expected to dissipate enough heat to support a theoretical PTDP level without causing an emergency shutdown of the processor. Since, as explained above, PTDP is strongly dependent on operating frequency and voltage, the theoretical PTDP level and, thus, the thermal solution, effectively limits the operating frequency of the processor.

The prior art has attempted to address the heat dissipation problem presented by portable computers. In one prior art example, the processor monitors its own temperature via a temperature sensor (e.g., a temperature sensitive diode). If the temperature reaches a threshold, the processor will throttle itself (e.g., reduce its operating voltage and/or frequency) to reduce the amount of heat being generated.

### BRIEF DESCRIPTION OF THE DRAWINGS

FIG. 1 is a perspective view of an example personal computer constructed in accordance with the teachings of the instant invention.

FIG. 2 is a block diagram of the portable computer of FIG. 1.

FIG. 3 is a schematic illustration showing an example thermal regulation circuit constructed in accordance with the teachings of the invention.

FIG. 4 is a circuit diagram illustrating an example manner of implementing the circuit of FIG. 3.

FIG. 5 is a more detailed view of the controller of FIG. 4.

FIG. 6 is a schematic illustration of the power amplifier of FIG. 4.

FIGS. 7A-7B are a flowchart illustrating an example program executed by the processor of FIG. 3.

FIG. 8 is a flowchart illustrating another example program.

### DESCRIPTION OF THE PREFERRED EXAMPLES

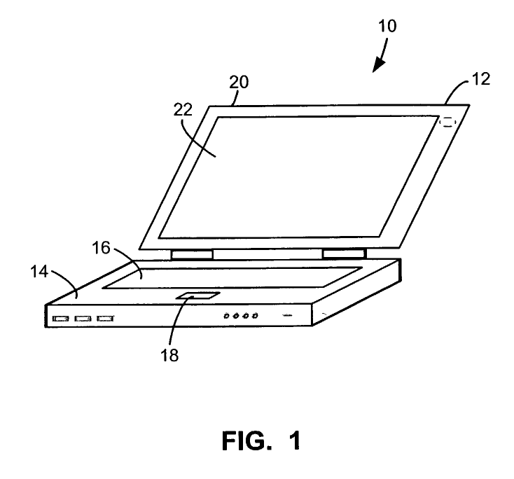

FIG. 1 is a perspective view of an example portable computer 10 constructed in accordance with the teachings of the invention. As used herein “portable computer” refers to any computer (e.g., PDA, laptop computer, notebook computer, etc.) that is designed to be carried by a person. Although in the illustrated example, the portable computer 10 is shown as including a clam-shell type housing 12 frequently associated with laptop and notebook computers, persons of ordinary skill in the art will appreciate that any other housing that is amenable to being carried by a person could alternatively be employed. For example, although the illustrated housing 12 includes (a) a base 14 containing input devices such as a keyboard 16 and touchpad 18, and (b) an upper display section 20 containing an LCD display 22 and hinged to the base 14 for closing the housing for transport in conventional fashion, persons of ordinary skill in the art will appreciate that a one piece housing (e.g., the housing typically used for a PDA such as the Palm Pilot™) or any other type of housing could alternatively be employed.

Persons of ordinary skill in the art will further appreciate that, although the illustrated examples are particularly well suited for use with portable computers, the teachings of the invention are in no way limited to that environment of use. On the contrary, the teaching of the invention can be applied in any environment of use, including, for example, desktop computers, which would benefit from the enhanced thermal regulation offered thereby.

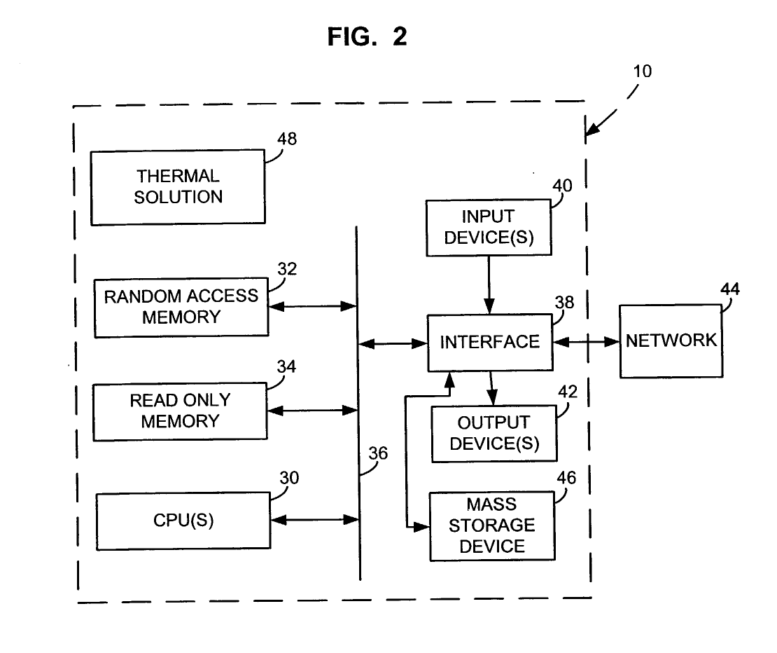

The portable computer 10 of the example illustrated in FIG. 1 includes the conventional hardware components typically found in a laptop or notebook computer. Thus, as shown in FIG. 2, the portable computer 10 includes a central processing unit 30 which is implemented, for example, by one or more Intel® microprocessors from the Pentium® family, the Itanium™ family or the XScale™ family.

Preferably, the microprocessor 30 has the ability to run at different power levels. The power consumption of a processor is directly proportional to V²F (where “V” is the supply voltage to the processor and “F” is the operating frequency of the processor). By reducing the voltage supplied to the processor 30 and/or the operating frequency of the processor 30, significant savings in power consumption are achieved. Reducing the voltage and/or operating frequency in this manner reduces the amount of heat generated by the processor.

As is conventional, the central processing unit 30 is in communication with a volatile memory 32 and a non-volatile memory 34 via a bus 36. The volatile memory may be implemented by SDRAM, DRAM, RAMBUS or any other type of random access memory device. The non-volatile memory 34 may be implemented by flash memory or any other desired type of memory device. Access to the memory 32 is typically controlled by a memory controller (not shown) in a conventional manner.

The portable computer 10 also includes a conventional interface circuit 38. The interface circuit 38 may be implemented by any type of well known interface standard, such as an Ethernet interface, and/or a universal serial bus (USB) and/or a third generation input/output (3GIO) interface.

One or more input devices 40 are connected to the interface circuit 38. The input device(s) 40 permit a user to enter data and commands into the CPU 30. The input device(s) can be implemented by, for example, a keyboard 16, a mouse, a touch-screen, a track-pad 18, a trackball, isopoint and/or a voice recognition system.

One or more output devices 42 are also connected to the interface circuit 38. The output devices 42 can be implemented, for example, by display devices (e.g., a liquid crystal display 22, a printer and/or speakers). The interface circuit 38 would, thus, typically include a graphics driver card.

The interface circuit 38 may also include a communication device such as a modem or network interface card to facilitate exchange of data with external computers via a network 44 (e.g., an Ethernet connection, a digital subscriber line (DSL), a telephone line, a coaxial cable, a cellular telephone system, etc.).

The portable computer 10 also includes one or more mass storage devices 46 for storing software and data. Examples of such mass storage devices include floppy disk drives, hard drive disks, compact disk drives and digital versatile disk (DVD) drives.

As shown in FIG. 2, the portable computer 10 is also provided with a thermal solution 48. The thermal solution 48 typically includes a conventional fan and conventional heat sink elements distributed throughout the housing of the portable computer 10. Additional features of the thermal solution 48 are discussed below.

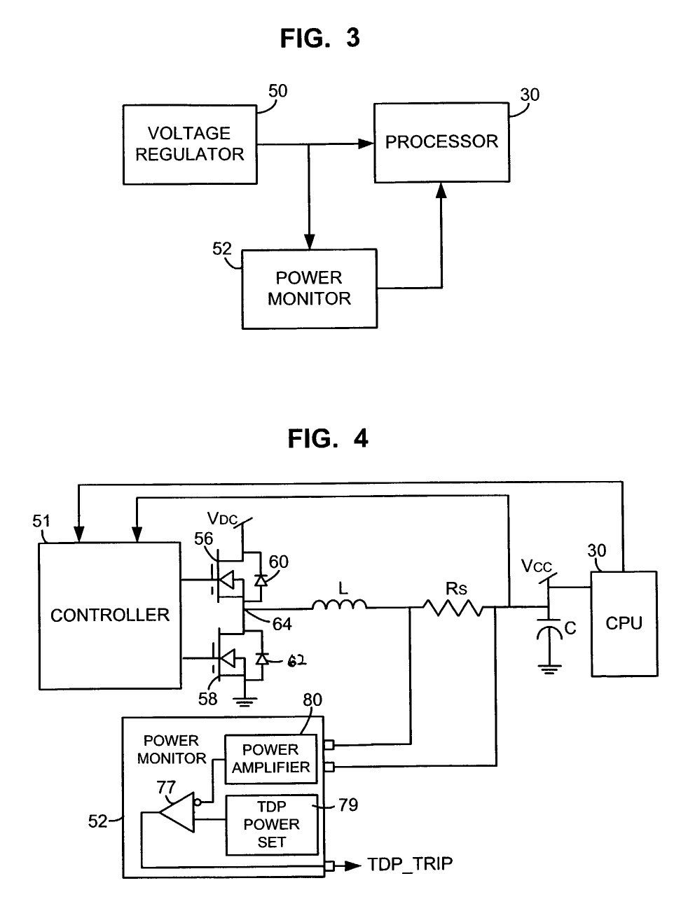

For the purpose of controlling power delivery to the processor 30, the portable computer 10 is further provided with a voltage regulator 50 (See FIG. 3). The voltage regulator 50 is of conventional design and operates to maintain the supply voltage from a battery or external power source to the processor 30 at a substantially constant level dictated by the processor 30 (e.g., a VCC of 5V). As explained above, the amount of power drawn by the processor 30 depends on several factors such as the operating frequency of the processor 30 and the operating voltage of the processor 30. In accordance with Intel's Speed-Step™ technology, the processor 30 is adapted to step its operating voltage and/or frequency up or down based on the demand it is experiencing. At times of low demand, the frequency and voltage are reduced to conserve power. Conversely, when demand increases, the operating voltage and frequency are increased to permit optimal completion of the task at hand.

To communicate the power needs of the processor 30 to the voltage regulator 50, the processor 30 is adapted to generate a voltage identification (VID) code. The VID code is fed back to the voltage regulator 50 where it is compared with the input voltage (VCC) to the processor 30. The results of this comparison are used to adjust the output of the voltage regulator 50 to drive the operating voltage VCC delivered to the processor 30 to the level demanded by the processor 30 as explained in further detail below.

For the purpose of comparing the power drawn by the processor 30 to the thermal design power (PTDP), the circuit of FIG. 3 is further provided with a power monitor 52. The power monitor 52 is adapted to compare the power drawn by the processor 30 (or a parameter proportional to the power) to a predetermined value representative of the thermal design power (PTDP) and to develop an output signal representative of that comparison.

As shown in FIG. 3, the output signal developed by the power monitor 52 is input to the processor 30. The processor 30 is programmed to respond to the output signal of the power monitor 52 by decreasing or increasing the power it draws (e.g., by reducing or increasing it operating voltage and/or operating frequency) and by developing a new VID code indicative of the new voltage demand. In other words, the circuit of FIG. 3 provides a feedback path (e.g., through the power monitor 52) coupled to the processor 30 and voltage regulator 50 to control the power drawn by the processor based on a comparison of the actual power drawn by the processor 30 (or a parameter proportional to that actual power) and the thermal design power (PTDP).

FIG. 4 illustrates one possible example way to implement the circuit of FIG. 3. In the example of FIG. 4, the voltage regulator 50 is a switching regulator. It includes a controller 51 with outputs respectively connected to the gates of two transistors 56, 58. A diode 60, 62 is respectively coupled between the drain and source of each of the transistors 56, 58 as shown in FIG. 4. These diodes 60,62 help steer current when the transistors 56, 58 are in their off state. The transistors 56, 58 are connected in series between a DC voltage source (VDC) and ground. By controlling the duty cycles of the transistors 56, 58, the controller 51 controls the voltage at the phase node 64 between the transistors.

More specifically, transistor 56 is only in an on-state when transistor 58 is in an off-state, and vice versa. When the transistor 56 is in the on state, the phase node 64 charges to the voltage VDC (less the voltage drop across the transistor 56). When the transistor 58 is in the on state, the phase node 64 discharges to ground. If during a given period, the transistor 56 is in the on-state half the time and the transistor 58 is in the on-state half of the time, the voltage at the phase node will be approximately one-half of VDC. By controlling the relative percentages of the period in which the transistors 56, 58 are in their respective on-states, the controller 51 controls the voltage appearing at the phase node 64.

As shown in FIG. 4, the voltage developed at the phase node 64 is delivered to the processor 30 through a stabilizer. The stabilizer includes an inductor (L), a current sense resistor (Rₛ), and a filtering capacitor (C). The inductor L and the capacitor C provide a low pass filter to provide a substantially clean DC voltage (VCC) to the processor 30. The current sense resistor Rₛ provides a means to monitor current flow to the processor 30 to provide, for example, over current protection. Specifically, if the current through the current sense resistor Rₛ becomes too high, an over current protection circuit (not shown) of conventional design causes the transistor 56 to enter the off-state to drop the voltage at the phase node 64 and, thus, drop VCC to protect the processor 30 against damage. The current sense resistor Rₛ can also be used to position the voltage VCC at a desired level.

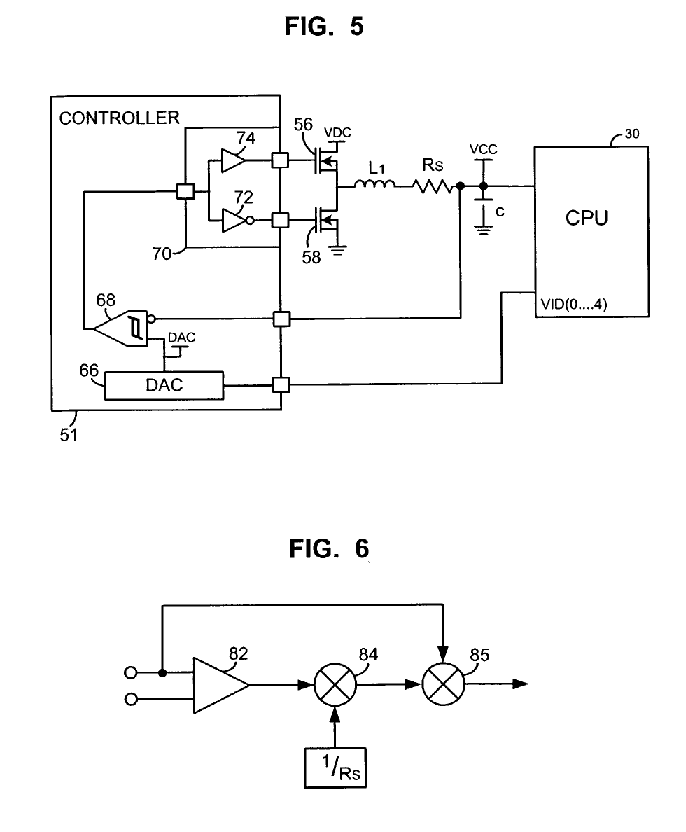

A more detailed illustration of the controller 51 of the voltage regulator 50 is shown in FIG. 5. To convert the voltage identification code (VID) output by the processor 30 to an analog signal, the controller 51 is provided with a digital-to-analog converter (DAC) 66. The converted VID code is compared with the current operating voltage (VCC) delivered to the processor 30 in a conventional comparator 68. More specifically, as shown in FIG. 5, the input signal representative of the current operating voltage VCC is inverted before being received at the comparator 68. The comparator 68 then adds the inverted voltage signal to the analog version of the VID code. The comparator 68 acts as an analog to digital converter in the sense that, if the VID code has a greater magnitude than the current operating voltage (VCC), the output of the comparator is logic high, but if the magnitude of the VID code is smaller than the current operating voltage (VCC), the output of the comparator 68 is logic low.

To convert the output of the comparator 68 into a duty cycle driving signal, the controller 51 is further provided with a driving circuit 70. As shown in FIG. 5, the driving circuit 70 includes an inverter 72 and a buffer 74. The inputs of the inverter 72 and buffer 74 are tied together, such that, when the output of the comparator 68 is high, the inverter 72 switches the transistor 58 to an off-state, and the buffer switches the transistor 56 to an on-state. On the other hand, when the output of the comparator 68 is low, the inverter 72 switches the transistor 58 to an on-state and the buffer 74 switches the transistor 56 to an off-state. In this way, the controller 51 controls the duty cycles of the transistors 56, 58 to set the input voltage (VCC) of the processor 30 at the level demanded by the processor 30 via the VID code.

In the example of FIG. 4, the power monitor 52 uses the voltage across the current sense resistor Rₛ as a measure of the load current drawn by the processor 30. This detected load current is multiplied with. the voltage (VCC) drawn by the processor 30 (which, in the example of FIG. 4, is the voltage appearing at one node of the current sense resistor Rₛ) to determine a power consumption of the processor 30.

More specifically, as shown in FIG. 4, the measured voltage at each node of the current sense resister Rₛ is input into a power amplifier 80. An example power amplifier 80 is shown in greater detail in FIG. 6. The power amplifier 80 of FIG. 6 computes a difference between the two input voltages using a differential amplifier 82 to develop a signal representative of the voltage drop across the resistor Rₛ. The output of the difference amplifier 82 is then turned into a signal representative of the load current by multiplying the output of the amplifier 82 with a constant equal to the admittance (i.e., 1/Rₛ) of the current sense resistor Rₛ in a conventional multiplier 84. The resulting load current signal is then multiplied in a conventional multiplier 85 with the input signal representative of the processor's operating voltage VCC to generate an output signal representative of the power drawn by the processor 30.

Returning to the example of FIG. 4, the output signal of the power amplifier 80 (which is a signal representative of the power drawn by the processor 30), is inverted and input into another amplifier 77. The amplifier 77 sums the inverted output signal with a signal representative of the thermal design power PTDP (a constant value based on the thermal solution as explained above) which may optionally be retrieved from a register 79. The amplifier 77 functions as an analog-to-digital converter in that the output of the amplifier 77 is logic high if the power drawn by the processor 30 exceeds the thermal design power PTDP, and is logic low if the power drawn by the processor 30 is below the thermal design power PTDP. The output of the amplifier 77 is the output of the power monitor 52.

The output (TDP_TRIP) of the power monitor 52 is input to the processor 30. The processor 30 is responsive to a logic high output signal (TDP_TRIP) from the power monitor 52 to first reduce its operating frequency . After the frequency is reduced, the processor 30 generates a new VID code indicating that the processor 30 needs less power. The voltage regulator 50 responds to the new VID code by determining that the voltage VCC delivered to the processor 30 is now too high, and by reducing the duty cycle of the transistor 56 to thereby reduce the operating voltage (VCC). If this decrease in the operating voltage VCC and the decreased load current drawn by the processor 30, as measured by the current sense resistor Rₛ, causes the power drawn by the processor 30 to fall below the thermal design power PTDP, the output (TDP_TRIP) of the power monitor 52 will switch to logic low thereby indicating that no further processor performance reductions are needed. If the power drawn by the processor 30 does not fall below the thermal design power PTDP, one or more additional reductions in processor performance may be conducted. Consequently, instead of experiencing an emergency shut down due to overheating, the portable computer 10 is able to keep operating, although at a reduced processor performance level (e.g., a slower frequency and/or voltage). Due to this active control of the processor's heat generation, persons of ordinary skill in the art will appreciate that the guard bands associated with the thermal solution may optionally be reduced relative to the prior art, or even eliminated. Since the operating speed of the processor 30 is actively managed to prevent excessive heat generation and emergency shut downs, persons of ordinary skill in the art will appreciate that a higher frequency processor can be safely used in the portable computer 10 without changing the thermal solution itself and without risk of increasing the likelihood of emergency shut downs.

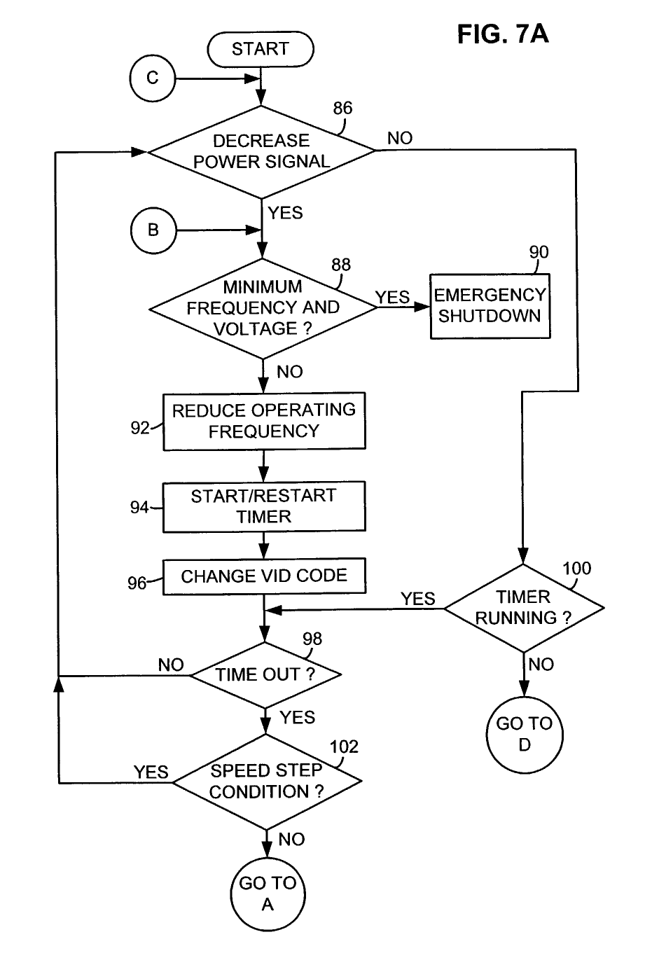

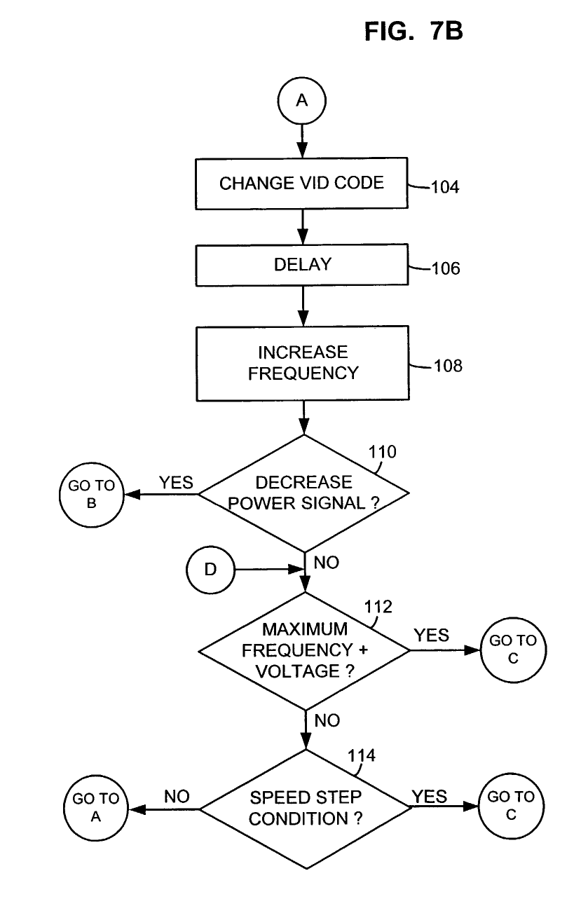

A flowchart of an example program to regulate the operating performance of the processor 30 based on the thermal design power PTDP of the portable computer 10 is illustrated in FIGS. 7A-7B. In this example, the program is for execution by the processor 30 and is embodied in software stored on a tangible medium such as a CD-ROM, a floppy disk, a hard drive, a digital versatile disk (DVD), or a memory associated with the processor 30, but persons of ordinary skill in the art will readily appreciate that the program could alternatively be executed by a device other than the processor 30 and/or embodied in firmware or dedicated hardware in a well known manner. Further, although the example program is described with reference to the flowchart illustrated in FIGS. 7A and 7B, persons of ordinary skill in the art will readily appreciate that many other methods of performing regulation of the processor operating performance based on thermal power dissipation may alternatively be used. For example, the order of many of the blocks may be changed, and some of the blocks described are optional.

When the program is initiated, the processor 30 enters a loop wherein it checks to see if a signal to decrease power (e.g., TDP_TRIP is high) has been received (block 86). Assuming, for purposes of illustration, that a decrease power signal is received (block 86), the processor 30 first determines if it is already in the minimum performance state (e.g., the processor is at the lowest operating frequency and voltage) (block 88). If so, the processor 30 performs an emergency shut down (block 90). Otherwise, the processor 30 immediately reduces its operating frequency (block 92). A timer (not shown) is then initiated (block 94) to keep track of how long the processor 30 has been in a reduced performance state (e.g., any state wherein the processor has a reduced operating voltage and/or frequency). The processor 30 then issues a new VID code to the voltage regulator 50 requesting the reduced operating voltage (block 96). If the timer has not timed out (block 98), control returns to block 86.

At block 86, the processor 30 determines if a further decrease power signal has been received. If so, control again proceeds through blocks 88-98 to further reduce the performance state of the processor 30 or perform an emergency shutdown. (If the timer is running when control reaches block 94, it is re-set and re-started). If, at block 86, a further decrease power signal has not been received, control proceeds to block 100.

Assuming for purposes of illustration that control has proceeded to block 100, the processor 30 determines whether the timer is running. If so, control proceeds to block 98 where the processor 30 determines if the timer has timed out. Control continues to loop through blocks 86-100 until the timer times out (block 98), the timer is not running (block 100), or an emergency shutdown occurs (block 90).

If the timer expires (block 98), the program assumes that the reduced performance state (e.g., any performance state below the maximum performance state) has been present long enough to permit the thermal solution to dissipate enough heat to permit a performance increase. Accordingly, the processor 30 checks to see if a speed step condition (e.g., low demand) is present dictating that it remains in the reduced power state (block 102). If so, control returns to block 86. Otherwise, control proceeds to block 104 (see FIG. 7B).

Assuming, for purposes of illustration, that no speed step condition dictating a reduced power performance state is present (block 102), the processor 30 changes the VID code to demand more power (block 104). The processor 30 then waits a predetermined length of time (e.g., 100 microseconds) to permit the voltage regulator 50 to respond (block 106). The processor 30 then increases its operating frequency (block 108).

The processor 30 next determines whether a decrease power signal has been received (block 110). If so, control returns to block 92 (FIG. 7A) where the operating frequency is immediately reduced (block 92) and the timer is restarted (block 94). If no decrease power signal has been received (block 110), control proceeds to block 112.

At block 112, the processor 30 determines if the maximum performance state (e.g., the processor is at the maximum operating voltage and maximum operating frequency) has been entered. If so, control returns to block 86 (FIG. 7A). If the maximum performance state has not been entered (block 112), control proceeds to block 114.

At block 114, the processor 30 determines whether a speed state condition is in place precluding movement to a higher performance state. If not, control returns to block 104 where the processor 30 changes the VID code to demand a higher operating voltage as explained above. On the other hand, if a condition precluding movement to a higher performance state is present (block 114), control returns to block 86 (FIG. 7A).

Returning to block 86, if no decrease power signal has been received, the processor 30 determines if a timer is running (block 100). If so, control returns to block 98. Otherwise, control proceeds to block 112 (FIG. 7B), where the processor 30 determines if it is in the maximum performance state as explained above.

From the foregoing, persons of ordinary skill in the art will appreciate that, in the foregoing example, it was assumed that more than two performance states are potentially available to the processor 30 (e.g., a maximum performance state, a minimum performance state, and at least one intervening performance state between the maximum and minimum performance states). Such persons will further appreciate that the disclosed teachings can alternatively be applied to processors with only two performance states. Moreover, persons of ordinary skill in the art will appreciate that, in the foregoing example, the processor 30 steps between the performance states in predefined discrete increments.

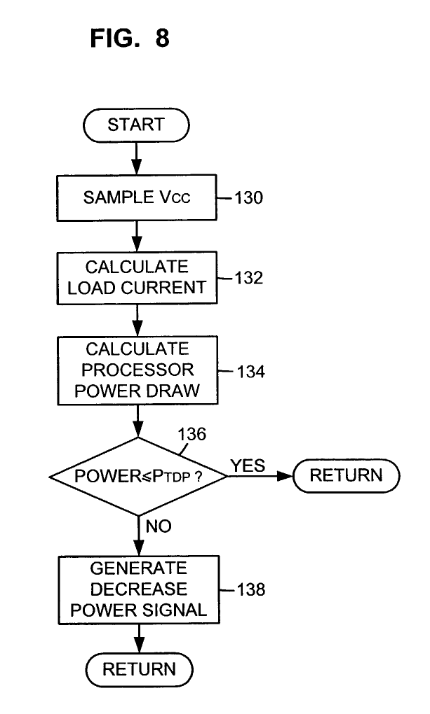

While in the examples illustrated above, the power monitor 52 is shown as being separate from the processor 30 (e.g., on a separate chip set), persons or ordinary skill in the art will readily appreciate that the power monitor 52 could alternatively (and preferably) be incorporated into the processor 30. A flowchart illustrating an example program to be performed by a processor 30 assuming the functionality of the power monitor 52 is shown in FIG. 8. In such circumstances, rather than integrating the power monitor 52 structure one-for-one into the processor 30, the processor 30 can eliminate much of the structure of the power monitor 52. For example, the processor 30 is already receiving the operating voltage VCC, so the processor 30 need only obtain a digital signal representative of that voltage via an analog to digital converter (ADC) as shown at block 130 of FIG. 8. Then, since the current sense resistor Rₛ has a constant resistance value, and V=IRₛ, the processor 30 has all the data it needs to calculate the load current (i.e., I=VCC/Rₛ) (block 132). Once the load current (I) is calculated (block 132), the processor 30 computes the power it is drawing (P=IVCC) (block 134). This power consumption value is then compared to the stored thermal dissipation power (PTDP) value (e.g., a value retrieved from memory) (block 136). If that comparison indicates that the processor 30 is drawing more than the thermal design power PTDP, a decrease power signal (TDP_TRIP) is generated (block 138). Otherwise, the routine of FIG. 8 ends and control returns to the program from which the routine was called.

The processor 30 can, for example, execute the example program shown in FIGS. 7A and 7B wherein a call to the routine of FIG. 8 is inserted before block 86 and block 110 of FIGS. 7A and 7B. The calls to the routine of FIG. 8 cause the processor 30 to repeatedly recalculate the decrease power signal (TDP_TRIP) as explained above. Thus, execution of the programs of FIGS. 7A-7B (as modified) and FIG. 8 ensures the power drawn by the processor does not exceed the thermal design power PTDP.

Although certain apparatus and methods implemented in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

What is claimed is:

1. A method of operating a computer comprising:
determining a power consumption of a processor;
comparing the determined power consumption to a theoretical power level that a thermal solution associated with the processor can dissipate; and
if the determined power consumption exceeds the theoretical power level, reducing the power consumption of the processor.

2. A method as defined in claim 1 wherein determining the power consumption comprises:
detecting a load current drawn by a processor;
measuring an operating voltage of the processor; and
multiplying the operating voltage with the load current.

3. A method as defined in claim 1 wherein the theoretical power level is substantially equal to a sum of a percentage of a dynamic power dissipation associated with the processor and an approximate leakage power associated with the processor.

4. A method as defined in claim 3 wherein the dynamic power dissipation is proportional to an operating frequency of the processor multiplied with a square of an operating voltage of the processor.

5. A method as defined in claim 1 wherein reducing power consumption of the processor comprises at least one of reducing an operating frequency of the processor and reducing an operating voltage of the processor.

6. A method as defined in claim 1 wherein reducing power consumption of the processor avoids performance of an emergency shut down of the processor.

7. For use in a computer having a processor, a power monitor comprising:
a current sense resistor associated with a power input of the processor;
an amplifier coupled to the current sense resistor to develop a signal representative of power dissipated by the processor; and
a comparison circuit to compare the signal output by the amplifier with a theoretical power level that a thermal solution associated with the processor can dissipate.

8. An apparatus as defined in claim 7 wherein the processor is responsive to an output of the comparison circuit indicating that the signal output by the amplifier exceeds the theoretical power level to reduce at least one of an operating voltage and an operating frequency.

9. An apparatus as defined in claim 7 wherein the comparison circuit comprises an adder that compares the signal output by the amplifier with the theoretical power level by adding them together.

10. An apparatus as defined in claim 9 further comprising an inverter to invert the signal output by the amplifier before the adder adds it to the predetermined threshold.

11. An apparatus as defined in claim 7 wherein the current sense resistor comprises part of a stabilizer in a voltage regulator.

12. A method of operating a computer comprising:
detecting power drawn by a processor;
comparing the power to a theoretical power level that a thermal solution associated with the processor can dissipate; and
if the power exceeds the theoretical power level, reducing at least one of an operating frequency and operating voltage of the processor.

13. A method as defined in claim 12 wherein detecting the power comprises:
measuring an operating voltage and load current associated with the processor; and
multiplying the operating voltage with the load current.

14. A method as defined in claim 12 wherein the theoretical power level is substantially equal to a sum of a percentage of a dynamic power dissipation associated with the processor and an approximate leakage power associated with the processor.

15. A method as defined in claim 14 wherein the dynamic power dissipation is proportional to an operating frequency of the processor multiplied with a square of an operating voltage of the processor.

16. A method of increasing a maximum operating frequency of a processor comprising:
monitoring power consumption by the processor; and
adjusting at least one of an operating frequency and an operating voltage of the processor based on a comparison between the power consumption of the processor and a theoretical thermal design power associated with the processor.

17. A method as defined in claim 16 further comprising reducing a power guard band associated with the processor.

18. A method as defined in claim 16 wherein the theoretical thermal design power is substantially equal to a sum of a percentage of a dynamic power dissipation associated with the processor and an approximate leakage power associated with the processor.

19. A method as defined in claim 17 wherein the dynamic power dissipation is proportional to the operating frequency of the processor multiplied with a square of the operating voltage of the processor.

20. A portable computer comprising:
a voltage regulator; and
a processor to control the power drawn by the processor from the voltage regulator based on a comparison of the power drawn by the processor and a thermal design power.

21. A portable computer as defined in claim 20 wherein the voltage regulator comprises a current sense resistor and a voltage across the current sense resistor is representative of a load current drawn by the processor.

22. A portable computer as defined in claim 20 further comprising a feedback path coupled to the processor and the voltage regulator, wherein the feedback path comprises an adder.

23. A portable computer as defined in claim 22 wherein the feedback path comprises an inverter and an amplifier.

24. For use with a portable computer including a processor and a thermal solution, a computer program stored on a tangible medium comprising:
first software to monitor power consumption of the processor; and
second software to decrease a performance level of the processor if the power consumption of the processor exceeds a power level that the thermal solution can handle.

25. A computer program as defined in claim 24 wherein the second software is responsive to a timer to increase the performance level of the processor.
